(19) United States
(12) Patent Application Publication
(10) Pub. No.: US 2009/0231252 A1
(43) Pub. Date: Sep. 17, 2009

(54) DISPLAY APPARATUS AND DISPLAY SYSTEM

(76) Inventor: Hiroshi Maegawa, Kanagawa (JP)

Correspondence Address: COOPER & DUNHAM, LLP, 30 Rockefeller Plaza, 20th Floor, NEW YORK, NY, 10112, US

(21) Appl. No.: 11/917,877

(22) PCT Filed: Mar. 26, 2007
(86) PCT No.: PCT/JP2007/057327

§ 371 Date: Dec. 17, 2007

(30) Foreign Application Priority Data
Mar. 24, 2006 (JP) 2006-083063
Feb. 15, 2007 (JP) 2007-035099

(51) Int. Cl. G09G 3/36

(52) U.S. Cl. 345/87

(57) ABSTRACT

A display unit displays information without a power supply. An area identifying unit determines whether the display apparatus is inside a permission area where a read of the information displayed on the display unit is permitted. A data controller deletes the information displayed on the display unit or displays other information on the display unit, when the area identifying unit determines that the display apparatus has moved from inside the permission area to outside the permission area.

### TECHNICAL FIELD

The present invention relates to a display apparatus having portability and a display system, and, more particularly to a display apparatus and a display system applicable to electronic paper and the like.

### BACKGROUND ART

A liquid crystal display that can generally rewrite displayed contents frequently is used for a display unit provided in personal computers (PCs) and personal digital assistants (PDAs). Because a certain size and weight are allowed for a personal computer, a radio function and a displayed content-changing function, and a large-capacity battery can be installed therein. Accordingly, a liquid crystal or an organic electroluminescence (EL) type that requires power for maintaining displayed contents can be used for the display unit, and the displayed contents can be changed naturally.

In recent years, to protect confidential contents displayed on a screen of a personal computer or the like, as a display apparatus used in the personal computer or a PDA, there has been known a type of a display apparatus that includes electronic paper which maintains displayed contents even if power supply from an external device is suspended, a display controller that controls display on the electronic paper, and a power-off detection circuit that detects suspension of power supply from the external device, where, when the power-off detection circuit detects suspension of power supply from the external device, the display controller deletes the displayed content on the electronic paper or deletes it after a certain period of time (see, for example, Japanese Patent Application Laid-Open No. 2004-69965).

Recently, there is a necessity of taking countermeasures against a problem that confidential information within a company leaks out via paper medium or the like. Explained below is an example in which a paper pamphlet is used as an information medium and there is a concern of information leakage, while there is a problem in portability because a display apparatus such as a notebook personal computer is used as the information medium.

In an in-company exclusive exhibition of a laboratory, for example, there are many pieces of information that are supposed to be read only in the laboratory, such as the list of the exhibition, the contents thereof, and exhibiting positions. These pieces of information are essential items for effective viewing and are distributed to visitors as paper pamphlets at the time of reception in most cases. However, the contents on the paper pamphlets are a trade secret, and taking out of the information to outside of the laboratory should to be prohibited. Therefore, a manager of the exhibition asks the visitors to cooperate in returning the paper pamphlets at the end of their viewing or when they go out of the laboratory.

However, in a cafeteria or the like in the laboratory at a lunch time, it can be difficult to offer food to all visitors due to restriction of the capacity in the place, and some visitors will go out for lunch to a restaurant or the like outside the laboratory. Further, if use of a mobile phone is prohibited in the laboratory, some visitors may go outside the laboratory for having communications to people in other places.

It is also bothersome to collect paper pamphlets and to redistribute them every time the visitors temporarily go outside the laboratory. Therefore, thorough collection of the paper pamphlets is difficult. Further, it takes a certain amount of cost for arranging manpower at an entrance for thorough collection of the paper pamphlets. When a notebook personal computer is used instead of paper pamphlets, the displayed contents of the notebook personal computer can be controlled by radio at the time of going out of the laboratory. However, the visitors cannot move around while watching the screen of the notebook personal computer all the time. Therefore, information leakage cannot be prevented with paper pamphlets or notebook personal computers.

Therefore, small and light electronic paper has been attracting attention as the means for preventing information leakage. A large-scale circuit for rewriting a display unit frequently and quickly and a large-capacity battery required for display for a long time cannot be installed on the electronic paper, for which the same portability as the paper is required.

As a type of conventional electronic paper, electrophoretic electronic paper having a memory function in its display unit is also known (see, for example, Japanese Patent Application Laid-Open No. 2003-107532). The electronic paper disclosed in Japanese Patent Application Laid-Open No. 2003-107532 does not require any power for maintaining displayed contents. Therefore, a battery is not required for the display, and there is no problem in using for a long time. As the configuration of the conventional electronic paper shown in FIG. 24, it includes an electrophoretic display unit 91, a driving circuit 92 for driving the display unit 91, a data interface (I/F) 93 that receives information from a recorder 7 such as a personal computer, and a data controller 94 that transmits the received information to the driving circuit 92 and controls the operation of the driving circuit.

When these units are connected to the recorder 7, power is supplied from the recorder 7 (thick line) to operate respective electric circuits. However, because power is only required at the time of rewriting the displayed content, the electric circuits do not operate in a state of being cut off from the recorder 7, and information is displayed by the memory function of the display unit 91.

However, in the conventional technique described in Japanese Patent Application Laid-Open No. 2003-107532, when the electronic paper is used in an in-company exclusive exhibition of a laboratory or the like, because the electronic paper has the same portability as paper, there is a problem that the electronic paper is taken out with the confidential information being displayed thereon.

The present invention has been achieved to solve the above problems, and it is an object of the present invention to provide a display unit and a display system that can conceal the displayed information in a specific area, while ensuring its portability and rewritability.

### DISCLOSURE OF INVENTION

A display apparatus according to one aspect of the present invention includes a display unit configured to display information without a power supply; an area identifying unit configured to determine whether the display apparatus is inside a permission area where a read of the information displayed on the display unit is permitted; and a data controller configured to delete the information displayed on the display unit or to display other information on the display unit, when the area identifying unit determines that the display apparatus has moved from inside the permission area to outside the permission area.

A display system according to another aspect of the present invention includes a display apparatus including a display unit configured to maintain a display of information without a power supply, an area identifying unit configured to determine whether the display apparatus is inside a permission area where a read of the information displayed on the display unit is permitted, and a data controller configured to delete the display of the information on the display unit or display other information on the display unit, when the area identifying unit determines that the display apparatus moves from inside the permission area to outside the permission area; and a station configured to transmit a permission area information signal indicating information of an permission area. The display apparatus receives the permission area information signal transmitted from the station, and determines whether the display apparatus is inside the permission area or outside the permission area, based on the received permission area information signal.

A display method according to still another aspect of the present invention includes displaying including a display unit displaying information without a power supply; determining whether a display apparatus is inside a permission area where a read of the information displayed on the display unit is permitted; and controlling including a data controller deleting the information displayed on the display unit or to display other information on the display unit, when it is determined that the display apparatus has moved from inside the permission area to outside the permission area.

### BRIEF DESCRIPTION OF DRAWINGS

FIGS. 1A and 1B are schematic diagrams of an appearance of electronic paper according to a first embodiment of the present invention;

FIG. 2 is an example of a microcapsule-electrophoretic display unit;

FIG. 3 is an example of a twist-ball display unit;

FIG. 4 is a schematic diagram for explaining a system using the electronic paper according to the first embodiment;

FIG. 5 is a block diagram of the electronic paper according to the first embodiment;

FIGS. 6A, 6B, and 6C are schematic diagrams for explaining a configuration of information transmitted from a recorder;

FIG. 7 is a block diagram of an area identifying unit according to the first embodiment;

FIG. 8 is a block diagram of a data controller according to the first embodiment;

FIG. 9 is a flowchart of an operation for rewriting displayed information when the electronic paper is connected to the recorder;

FIG. 10 is a flowchart of an operation when the electronic paper according to the first embodiment is shifted to outside of a read-permitted area (permission area);

FIG. 11 is a schematic diagram for explaining a system using electronic paper according to a second embodiment of the present invention;

FIG. 12 is a block diagram of the electronic paper according to the second embodiment;

FIG. 13 is a block diagram of the area identifying unit according to the second embodiment;

FIG. 14 is a block diagram of the data controller according to the second embodiment;

FIG. 15 is a flowchart of an operation when the electronic paper according to the second embodiment is shifted to outside of the permission area;

FIG. 16 is a schematic diagram for explaining an example in which a display layer is covered with a superposed display layer;

FIG. 17 is a schematic diagram for explaining a generally used twisted nematic (TN) type liquid crystal;

FIG. 18 is a schematic diagram for explaining a vertical alignment (VA) type liquid crystal applied to a second display layer;

FIG. 19 is a block diagram of electronic paper according to a third embodiment of the present invention;

FIG. 20 is a flowchart of an operation when the electronic paper according to the third embodiment is shifted to outside of the permission area;

FIG. 21 is a schematic diagram for explaining a system using a-signal indicating an individual RFID;

FIG. 22 is a block diagram of a station;

FIG. 23 is a table of information of areas and stations; and

FIG. 24 is a block diagram of conventional electronic paper.

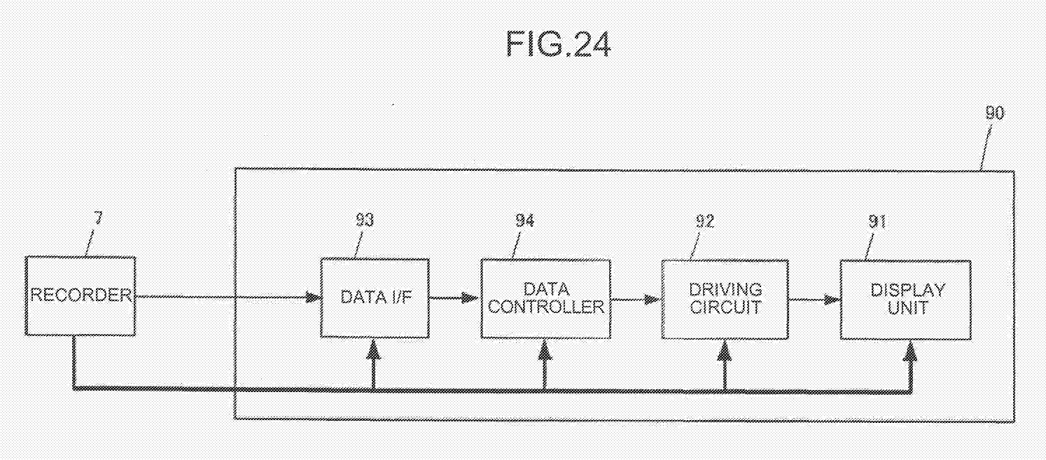

### BEST MODE(S) FOR CARRYING OUT THE INVENTION

Exemplary embodiments of the present invention are explained in detail below with reference to the accompanying drawings.

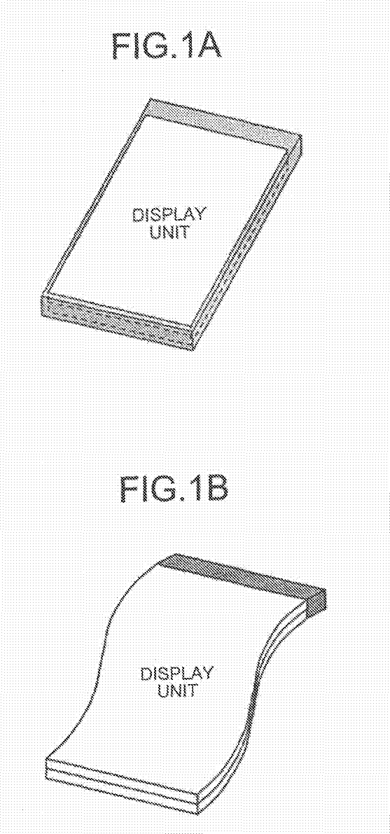

FIGS. 1A and 1B are schematic diagrams of an appearance of electronic paper according to a first embodiment of the present invention. The electronic paper is formed of a plate type having a moderate thickness such as a notebook as shown in FIG. 1A, or a paper type such as foldable thin paper as shown in FIG. 1B.

The plate type electronic paper shown in FIG. 1A includes, for example, a liquid crystal electronic paper and an organic EL electronic paper. For the paper type electronic paper shown in FIG. 1B, a thin and foldable electric circuit board is used, and a small-capacity battery is mounted thereon, because minimum power required for changing the displayed content needs to be held. The display principle can be largely divided into two, that is, a type requiring power for maintaining the displayed content, and a type in which the display unit itself has a memory function and does not require power. The paper type electronic paper shown in FIG. 1B includes a microcapsule electrophoretic type and a twist ball type.

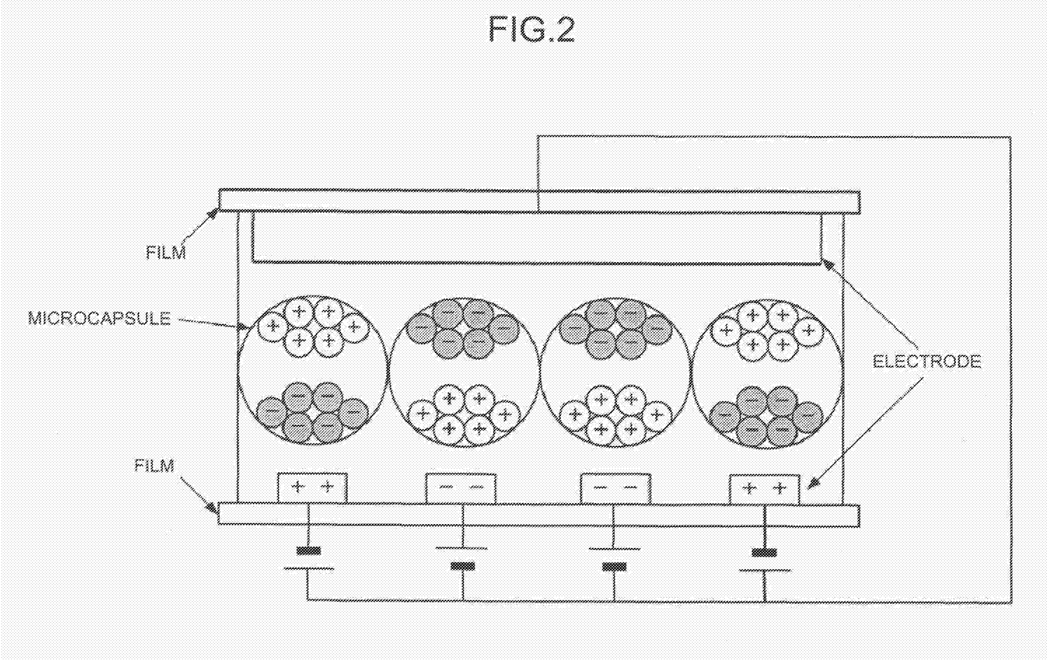

FIG. 2 is an example of a microcapsule-electrophoretic display unit, which does not require power for maintaining the displayed content. Black and blue particles charged to negative polarity and white particles charged to positive polarity are contained in transparent microcapsules, and the microcapsules are put between films having a transparent electrode such as indium tin oxide (ITO). When a voltage is applied to apply negative electric charge to a specific part of a lower face, the white particles move to a lower part of the microcapsule and the black and blue particles electrophoretically migrate toward an upper face. Therefore, a white and black (blue) image is displayed on the electronic paper. When positive electric charge is applied to the whole face, the white particles move to an upper part of the microcapsule. Therefore, the surface becomes white, and this is the same reaction as deleting the image.

The microcapsule-electrophoretic electronic paper requires electric power to move the white and black particles at the time of rewrite. However, because the white and black particles normally stay on the electrode due to electrostatic adsorption or intermolecular force, the power is not required to maintain the displayed content, which means that the display unit itself has a function for storing the displayed content, that is, a memory function.

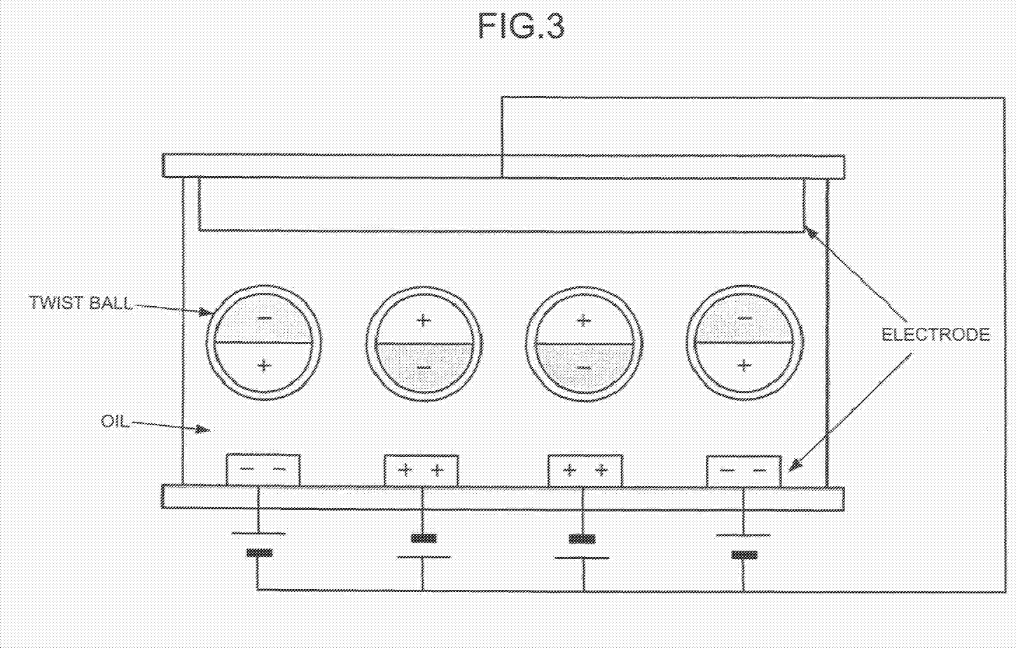

An example of the twist-ball (or Gyricon bead) display unit is shown in FIG. 3. Balls having a spherical diameter of 10 micrometers to 100 micrometers, which are painted, respectively, in two colors (for example, white and black) for each hemisphere, have charged states (plus and minus) corresponding to the respective colors, and are buried in a transparent insulating sheet put between a pair of electrodes.

The ball painted in two colors is supported in an insulating liquid such as silicon oil in a cavity slightly larger than the ball diameter, and when the voltage is applied, the charged ball rotates, and either one color of the colors painted for each hemisphere appears. Because the rotated ball is fixed on the wall of the cavity by electrostatic adsorption even if the voltage is released, to maintain a constant state, the displayed content is maintained without power. That is, the state at the time of rotating the balls painted in two colors is displayed as an image, by changing the polarity of the applied voltage.

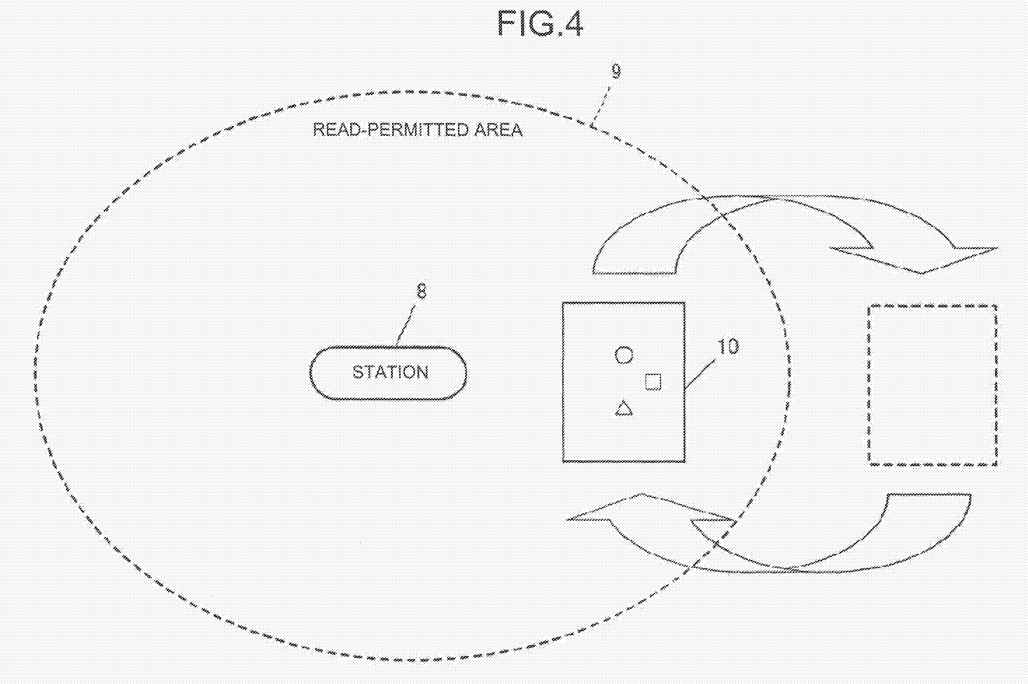

FIG. 4 is a schematic diagram for explaining a system using the electronic paper according to the first embodiment. It is assumed that an electronic paper 10 is in a read-permitted area (permission area) 9 and is displaying confidential information such as a trade secret. The permission area 9 is a range in which the confidential information can be read, when the displayed content is the confidential information. The electronic paper 10 displays information in a power saving mode when the electronic paper 10 is in the permission area 9.

The electronic paper 10 monitors a radio signal from a station 8 placed in a specific place such as a center of the permission area 9 all the time, and analyzes strength of monitored signal, frequency of the monitored signal, and modulation information to determine whether the electronic paper 10 is inside the permission area 9.

The station 8 can share the installation place with common-use office equipment such as a copying machine, or can be installed in the common-use office equipment. When an entire building is to be designated as the permission area 9, the entire building can be designated as the permission area 9 by installing the station 8, respectively, in each room in the building. Faint radio or specific small power radio can be used as the radio to be used by the station 8. A modulation signal by illumination light such as LED can be used as a communication means with the station 8.

As shown in FIG. 4, when it is assumed that a user takes out the electronic paper 10 from the permission area 9, the electronic paper 10 determines that it is outside of the permission area 9, cancels the power saving mode, and replaces the confidential information being displayed by pre-stored information on the display, or deletes the confidential information being displayed.

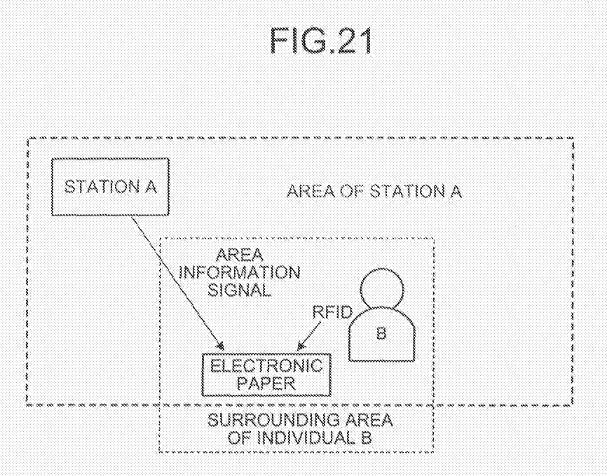

FIG. 22 is a configuration example of the station 8.

The station 8 in FIG. 22 transmits an area information signal (permission area signal) by radio wave. The station 8 includes a carrier generating unit 81, a modulating unit 82, an amplifier 83, a transmitting unit 84, and a control unit 85.

The carrier generating unit 81 determines a frequency of the signal (area information signal) to be transmitted (emitted) from the station. The frequency is selected from a frequency range in which a receiver in the electronic paper can receive the signal. It is desired that a plurality of frequencies can be selected.

The modulating unit 82 performs amplitude modulation or phase modulation for superimposing a station ID relative to the signal of a constant frequency determined by the carrier generating unit 81. At this time, synchronization information and the like can be superimposed on the signal so that ID information indicating the station ID can be easily discriminated.

The amplifier 83 amplifies the signal on which the ID information and the synchronization information are superimposed by the modulating unit 82 with a predetermined gain.

The transmitting unit 84 transmits (emits) a radio wave signal (area information signal) according to the signal amplified by the amplifier 83.

The control unit 85 gives an instruction, respectively, to the carrier generating unit 81, the modulating unit 82, the amplifier 83, the transmitting unit 84, and the control unit 85 to control the operation of the station. The information to be superimposed in the modulating unit on the signal of the constant frequency determined by the carrier generating unit can include output strength of the station as additional information added to the above example. For example, when the output strength is added as the additional information, the electronic paper 10 can correspond to a case such that the output strength has to be changed to a value different from the output strength used in an original station, when the original station has a failure and is replaced by another station. Further, if permitted strength and output strength are set (included) in read permission information prestored in the electronic paper, the difference between the output strength included in the read permission information and the output strength of the area information signal can be detected, thereby correcting the permitted strength to achieve an original purpose of restricting the distance from the station reliably.

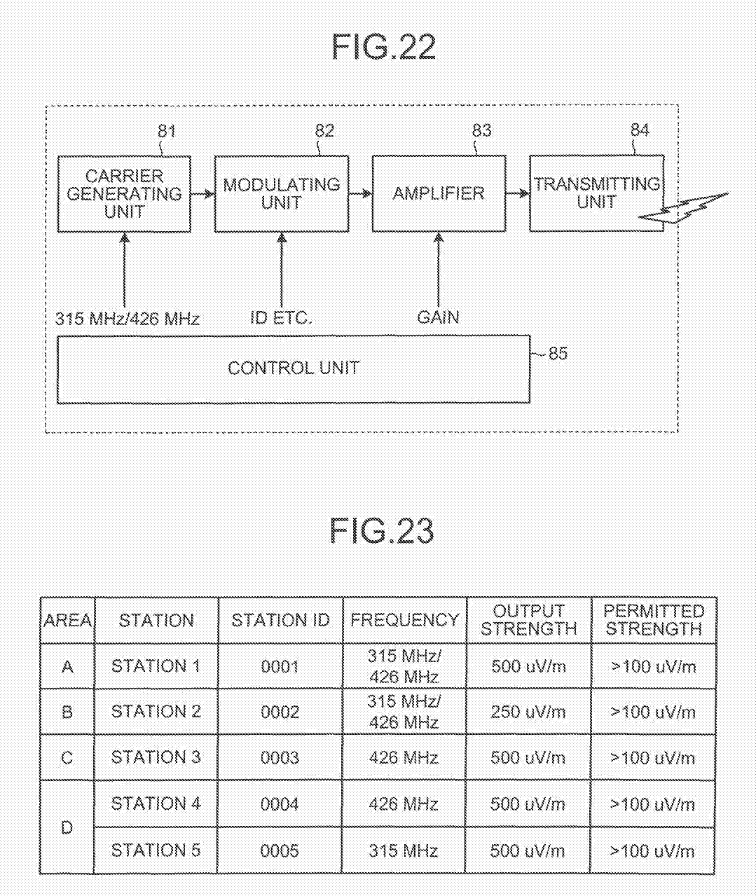

A relationship between the permission area and area recognition information is explained with reference to FIG. 23.

FIG. 23 is a table in which the station and the permission area are associated with each other. In the table shown in FIG. 23, five stations (stations 1 to 5) are installed, and four areas (A to D) are set. The station TD, which is information identifying the station is added to each station. At least one station is associated with each area. The receiver in the electronic paper can be simplified if the frequency of the area information signal is fixed to a predetermined value. However, it is desirable that a plurality of stations can be selected, because an interference with other equipment can be considered. It is desired that not only the frequency but also the output strength can be changed, to secure a desired area corresponding to surroundings such as a width of a room or an obstacle. It is also desired to control the lowest field strength indicating a boundary of the area.

With reference to FIG. 23, in a station A, output with a frequency of 315 megahertz or 426 megahertz is possible. However, 315 megahertz is set as the frequency of the area information signal. The output strength is set so that the field strength at a place away by 3 meters has an output strength of 500 μV/m corresponding to a specific maximum value of faint radio. The station ID is superimposed on the area information signal by amplitude modulation or phase modulation and is output to discriminate the station A from other stations. The station ID (station) is discriminated by demodulating the information by the electronic paper. Because the field strength is inversely proportional to the distance, when an area up to a place away by 15 meters is designated as an area A, the area A is set as a range capable of receiving the field strength equal to or higher than 500 (μV/m)×3 (m)÷15 (m)=100 (μV/m). The electronic paper receives the area information signal output from the station, obtains the frequency, the station ID, and a reception strength to compare these with the read-permitted information pre-stored in the electronic paper, and if determining that the electronic paper is positioned in a permitted ranger permits display on the electronic paper. In this example, the field strength is considered as an item. However, because an attenuation factor of the electric field strength can be presumed from calculation if the output strength of the station is fixed, the distance from the station can be used as an item. For example, if the received strength is 250 μV/m, the distance from the station 1 can be calculated as about 6 meters.

Because the permitted range of an area B is limited only to the vicinity of the station 2, the output strength of the station (station 2) is set to 250 μV/m, which is weaker than that of the station (station 1) in the area A. In this manner, by setting the permitted range by making the output strength of the station variable, the reception strength (permitted strength) of the electronic paper can be uniformly set to 100 μmV/m (see FIG. 23). Accordingly, the configuration of the receiver can be simplified. Needless to say, such a method can be used that the receiver of the electronic paper has a configuration capable of flexibly determining the strength, and setting of the permitted strength is changed. In an area C, a frequency of 426 megahertz is set, which is different from that in the area A or B. Further, as in an area D, the area can be set to include the stations 4 and 5. In other words, the area and the station need not always be in one-to-one correspondence with each other, and a plurality of stations can be associated with one area. Further, stations arranged in one position can have the same setting and the same ID.

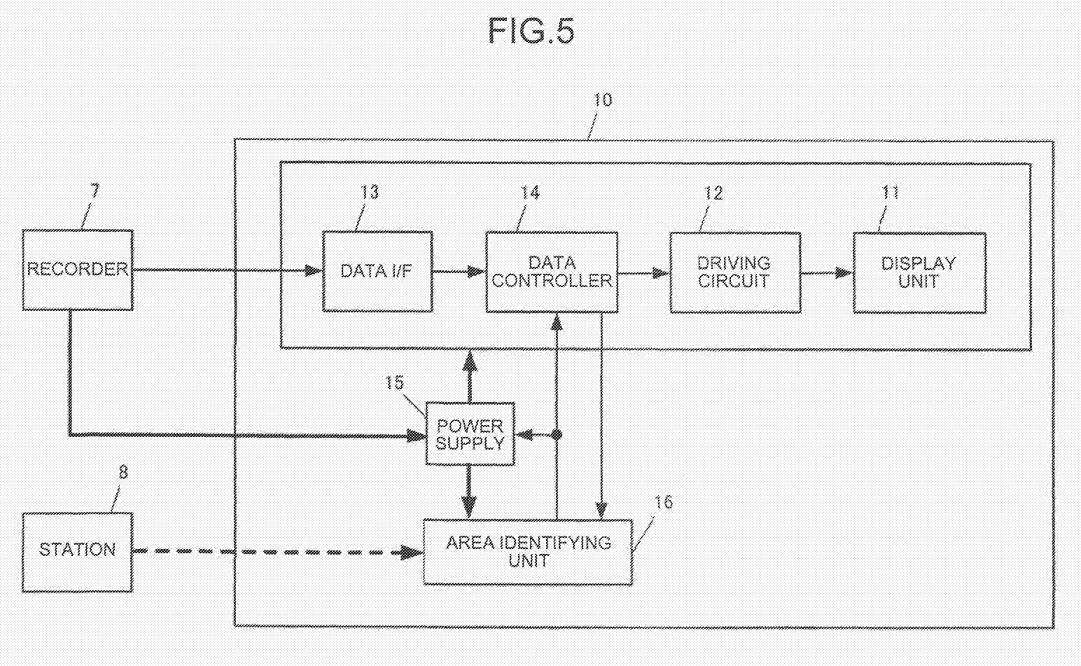

FIG. 5 is a block diagram of the electronic paper according to the first embodiment.

The electronic paper 10 includes a display unit 11 that displays information, a driving circuit 12 that drives the display unit 11, a data I/F 13 that receives information transmitted from the recorder 7, a data controller 14 that transmits the received information to the driving circuit 12 to control the operation of the driving circuit 12, a power supply 15 having a charging function, and an area identifying unit 16 that identifies whether the electronic paper 10 is in the permission area.

The recorder 7 is formed of a personal computer or the like to be connectable to the electronic paper 10 by a universal serial bus (USB) or the like. The recorder 7 records the confidential information and the like to be displayed on the electronic paper 10, and transfers the confidential information to the electronic paper 10 when the recorder 7 is connected with the electronic paper 10. The recorder 7 can record and manage the table set as shown in FIG. 23, or can create or change the setting relating to the stations managed in the table. The recorder 7 can transfer information representing non-confidential displayed contents to the electronic paper 10, as required.

For example, the display unit 11 is formed of a display unit having a memory function such as the microcapsule electrophoretic type or the twist ball type as shown in FIGS. 2 and 3. The driving circuit 12 can be a circuit, for example, which directly drives the electrode in the display unit 11, and an active matrix type using TFT for each pixel can be used.

The data I/F 13 can be connected to the recorder 7 so that the information and the like displayed on the display unit 11 can be rewritten. The connection of the data I/F 13 with the recorder 7 can be by a cable connector or can be wireless.

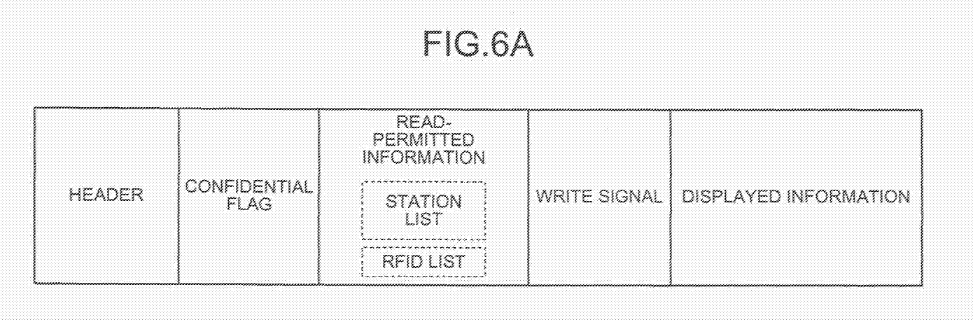

A block diagram of the information transmitted from the recorder 7 is shown in FIG. 6A. The information shown in FIG. 6A includes a header indicating a head, information to be displayed on the display unit 11, a confidential flag indicating whether the content of the displayed information is confidential or non-confidential, read-permitted information indicating the read permitted range when the content is confidential, and a write signal indicating whether the driving circuit 12 is to be operated. When the confidential flag is 0 (non-confidential), the information displayed on the display unit 11 is not changed, regardless of whether the electronic paper 10 is inside or outside of the permission area.

As shown in FIG. 6B, in the read-permitted information, area information indicating the permission area, which is the station ID (or can be replaced by an illumination ID) in a range where read of the information is permitted, an ID such as RFID for specifying a mobile object such as a person, and a list of signal frequency for superimposing the area information are associated with each other. As shown in FIG. 6C, the read-permitted information can be managed in a table in which the station ID, the frequency of the area information signal output from the station ID, information relating to the permitted strength indicating that the information can be read when the strength of the radio wave received by the receiver in the electronic paper is equal to or higher than 100 μV/m, and the output strength or the area information signal in the station are associated with each other, instead of the table shown in FIG. 6B. An amount of the read-permitted information is desired to be variable corresponding to a size of the read permitted range. The read-permitted information is created from a table shown in FIG. 23 recorded in the recorder, by extracting only the information relating to necessary items by the recorder. In the information transmitted from the recorder 7, if the confidential flag indicates non-confidential, the read-permitted information can be omitted.

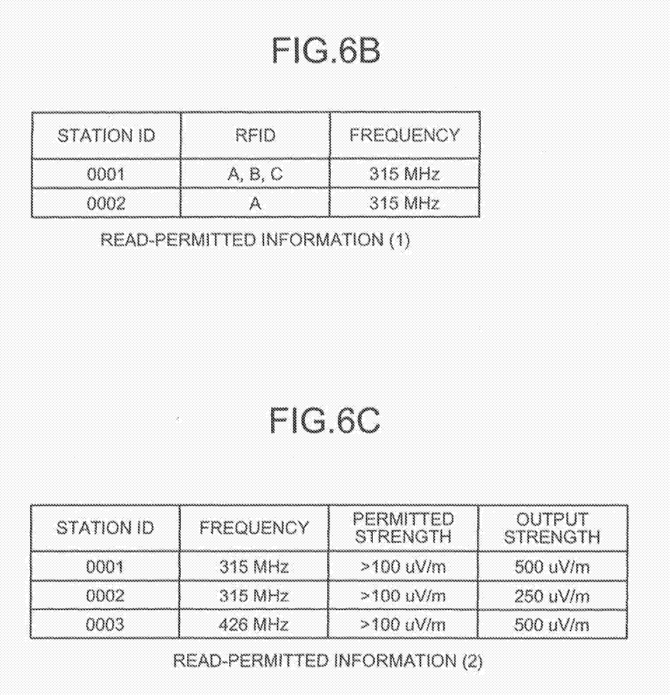

The area identifying unit 16 determines whether the electronic paper 10 is in the permission area, by receiving the area information signal expressing area information from the station 8. A block diagram of the area identifying unit 16 is shown in FIG. 7.

As shown in FIG. 7, the area identifying unit 16 includes a receiver 16A, an amplifier 16B, a frequency detecting unit 16C, a data detecting unit 16D, a strength detecting unit 16E, an area recognizing unit 16F, a storage unit 16G formed of RAM and ROM, and a control unit 16H formed of a CPU or the like.

The receiver 16A is formed of a radio antenna when a carrier of the area information signal transmitted from the station 8 or other stations is a radio signal, or a photodetecting unit when the carrier of the area information signal is a flash signal. The amplifier 16B amplifies the signal received by the area identifying unit 16.

When the frequency of the area information signal is predetermined in correspondence to each station ID, the frequency detecting unit 16C detects the frequency of the area information signal output from the amplifier 16B, and the area recognizing unit 16F specifies the station ID (station) from the frequency detected by the frequency detecting unit 16C.

When the frequency of the area information signal is predetermined, the data detecting unit 16D demodulates the modulated (for example, phase modulated or amplitude modulated) signal, and the area recognizing unit 16F specifies the station ID obtained by modulating by the data detecting unit 16D.

The strength detecting unit 16E detects the strength of the area information signal for accurately specifying the station ID to predict the distance from the station 8 (or illumination) based on the detected strength.

The area recognizing unit 16F generates area recognition information indicating the area where the electronic paper 10 is positioned, based on the distance presumed by the strength detecting unit 16E or the specified station ID, to output the area recognition information to the control unit 16H. When there is a plurality of the stations 8, the area where the nearest station 8 is positioned is specified based on the received field strength.

The control unit 16H compares the area indicated by the area recognition information output by the area recognizing unit 16F with the read-permitted information stored in the storage unit 16G, to output a rewrite signal set to High(1) to the data controller 14, when these pieces of information agree with each other. If these pieces of information do not agree with each other, the control unit 16H outputs the rewrite signal set to Low(0) to the data controller 14. When the data controller 14 outputs the read-permitted information, the control unit 16H stores the output read-permitted information in the storage unit 16G. When the receiver 16A cannot receive the area information signal, the control unit 16H outputs the rewrite signal set to Low(0) to the data controller 14.

The area identifying unit 16 can transmit information relating to the ID allocated to each electronic paper 10 or relating to the content to be displayed to the station 8. In this case, a security policy, which is a condition relating to use restriction of the electronic paper 10, is preset in the station 8, and the station 8 determines whether the information relating to the ID or the content to be displayed conforms to the security policy. The station 8 transmits the area information signal indicating that the information conforms to the security policy to the electronic paper 10. The security policy can be updated corresponding to the operation status of the system.

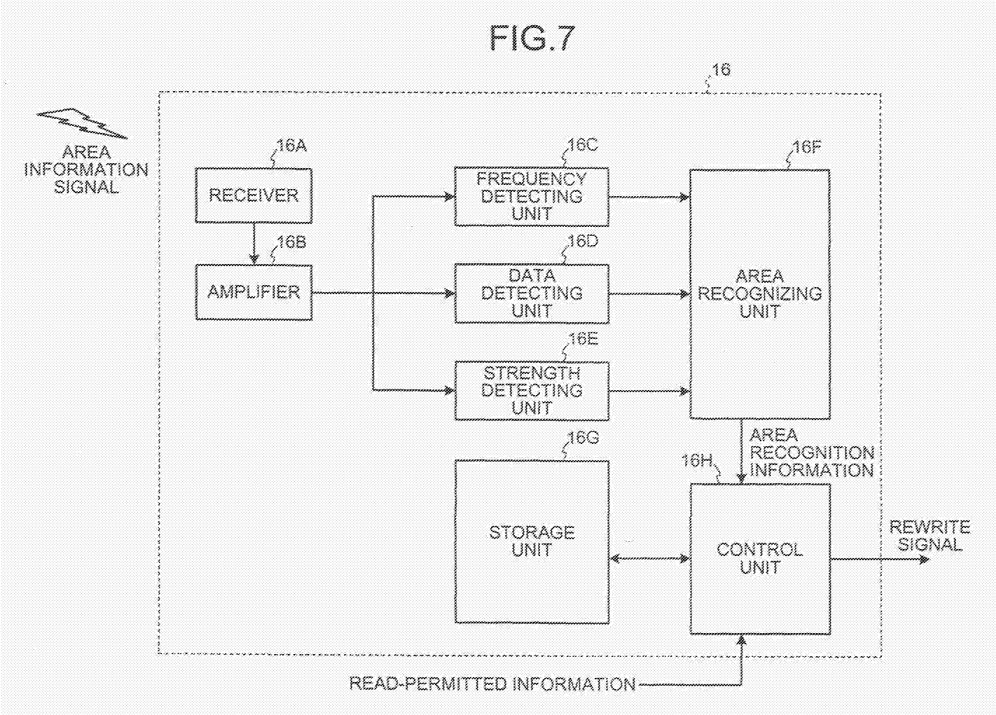

FIG. 8 is a block diagram of the data controller according to the first embodiment. The data controller 14 includes a memory 14A that stores information indicating a non-confidential displayed content (hereinafter, non-confidential information), a header detection circuit 14B that detects a header of the information transmitted from the recorder 7, a write-signal detection circuit 14C that detects the write signal, a selector 14D that selects the memory 14A or the header detection circuit 14B, logic circuits 14E and 14F, and a confidential-flag detection circuit 14G that detects the confidential flag.

Information indicating a character such as “out of area” is suitable for storage information in the memory 14A, and a user can rewrite the displayed content. A simple serial data transmission circuit that outputs all 0 or all 1 instead of characters is desirable from a standpoint of power consumption and circuit size. When all 0 or all 1 is output, the displayed content becomes all white or all black (blue).

The header detection circuit 14B detects a header of the information transmitted from the recorder 7, and the write-signal detection circuit 14C outputs 1 to the logic circuit 14F when the write signal indicates that the driving circuit 12 is to be operated, and outputs 0 to the logic circuit 14F when the write signal indicates that the driving circuit 12 is not to be operated.

The rewrite signal output from the area identifying unit 16 is input to the selector 14D. The rewrite signal becomes High when the electronic paper 10 is away from the permission area, and becomes Low when rewrite of the displayed information has finished. The selector 14D selects the memory 14A when the rewrite signal is High, and selects the header detection circuit 14B when the rewrite signal is Low. When selecting the memory 14A, the selector 14D outputs the information in the memory 14A to the driving circuit 12, and when selecting the header detection circuit 14B, the selector 14D outputs the displayed information of information shown in FIG. 6A to the driving circuit 12.

The logic circuit 14E designates a case that the confidential flag indicates confidential as 1, and a case that the confidential flag indicates non-confidential as 0, to calculate logical product (AND), The logic circuit 14F outputs the calculation result of logical add (OR) as an enable signal to the driving circuit 12, and when the enable signal is 1, the driving circuit 12 operates.

In the configuration of the data controller 14, in a case that the confidential flag when the electronic paper 10 receives the information from the recorder 7 is 0 (non-confidential), the electronic paper 10 has been cut off from the recorder 7, and therefore the electronic paper 10 does not receive the write signal and the displayed content is not rewritten. To avoid a case such that the operation becomes different according to whether the place at the time of writing information by the recorder 7 is in the permission area, when the electronic paper 10 is connected with the recorder 7, the signal from the area identifying unit 16 can be cut off.

In the example of the data controller 14 shown in FIG. 8, the data controller 14 has a block configuration mainly formed of a logic circuit, however, the data controller 14 can be configured as a program executed by the CPU.

The power supply 15 can be formed of, for example, a small and thin battery such as a film battery, and has a capacitor, which is a charging function, charged when being connected to the recorder 7. For example, when the electronic paper 10 is connected to the recorder 7 in the permission area, the power supply 15 supplies power to the respective blocks in the electronic paper 10.

When the electronic paper 10 is cut off from the recorder 7, the electronic paper 10 switches to the power saving mode, in which the electronic paper 10 is supplied with only the necessity minimum power. At this time, because the displayed content is maintained by the memory function of the display unit 11, the power is not required unless the displayed content is changed. Therefore, when the electronic paper 10 is cut off from the recorder 7, the power supply 15 does not supply the power to the data controller 14, the driving circuit 12, the display unit 11, the data T/F 13, because the power is not required. However, if partial power to the area identifying unit 16 can be provided by the radio wave from the station 8 or light from an LED illumination, power consumption can be further reduced, which is preferable. The power supplied to the data I/F 13 can be either from a built-in power supply in the data I/F 13 or directly from the recorder 7.

When the electronic paper 10 is cut off from the recorder 7, the power supply 15 can supply power so that only the minimum function of the area identifying unit 16 can be operated. When the area identifying unit 16 determines that the electronic paper 10 has shifted to outside of the permission area, the power supply 15 cancels the power saving mode to supply power to the data controller 14, the driving circuit 12, and the display unit 11.

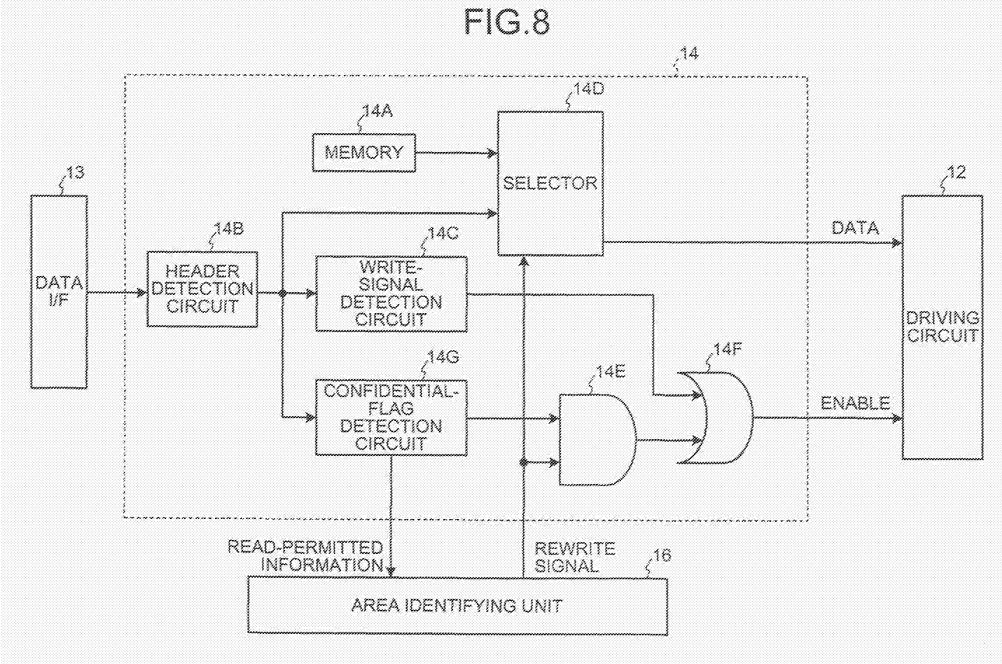

An example of the operation of the electronic paper according to the first embodiment is explained with reference to the drawings. FIG. 9 is a flowchart of an operation for rewriting the displayed information when the electronic paper is connected to the recorder.

The electronic paper 10 is first connected to the recorder 7 (step S1). The recorder 7 supplies power to the electronic paper 10 to charge the power supply 15 in the electronic paper 10, if the power supply can be charged. The power is also supplied to the data controller 14.

The data controller 14 suspends a partial function of the area identifying unit 16 in order not to output the rewrite signal to the area identifying unit 16 (step S2). Step S2 is executed for avoiding a case such that the operation becomes different according to whether the recorder 7 is inside or outside of the permission area. The data controller 14 receives the information shown in FIG. 6A from the recorder 7 (step S3).

The data controller 14 obtains the read-permitted information from the received information to store the read-permitted information in the area identifying unit 16 (step S4). The data controller 14 also obtains the displayed information from the received information by setting the rewrite signal to Low, and rewrites the displayed content of the display unit 11 by the obtained displayed information when the write signal indicates to operate the driving circuit 12 (step S5).

Upon disconnecting the electronic paper 10 from the recorder 7 (step S6), charging of the power supply 15 is suspended. The power supply 15 then supplies power to the area identifying unit 16 and the like, the suspended partial function of the area identifying unit 16 starts to operate, and the area identifying unit 16 starts output of the rewrite signal (step S7). Power supply of the data controller 14 and the like is suspended.

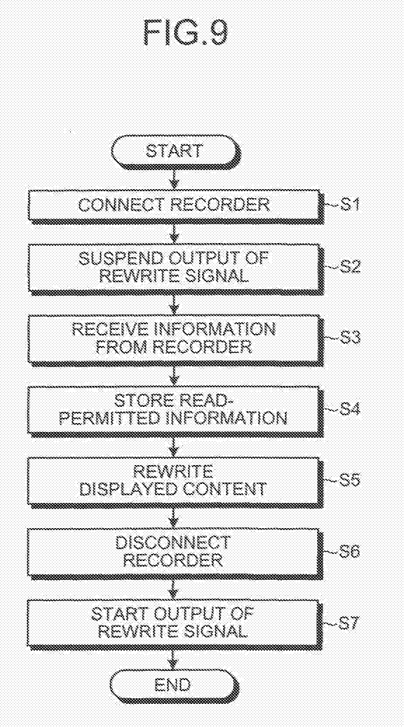

FIG. 10 is a flowchart of an operation when the electronic paper 10 is shifted to outside of the permission area. The displayed information when the confidential flag is High has been already displayed on the display unit 11.

The area identifying unit 16 determines whether the area information signal has been received continuously, and compares the received area information with the pre-stored read-permitted information (step S11), to determine whether the electronic paper 10 is in an appropriate permission area (step S12). The area identifying unit 16 can determine whether the area information signal can be received intermittently for every several seconds at step S11.

The area identifying unit 16 executes step S11 if the electronic paper 10 is in the permission area at step S12 (step S13). When the electronic paper 10 moves from inside to outside of the permission area and the rewrite signal is changed from Low to High, the power supply 15 starts to supply power to the data controller 14 and the like (step S14).

After power is supplied, the data controller 14 rewrites the displayed content being displayed on the display unit 11 by characters of “out of area” or by non-confidential information in which all face is turned to white, and the rewrite signal changes from High to Low (step S15). Subsequently, power supply to the data controller 14 and the like is suspended (step S16).

The electronic paper according to the first embodiment deletes the display or displays the non-confidential information when it is determined that the electronic paper has moved from inside to outside of the permission area. Accordingly, the confidential information can be concealed in the permission area, while maintaining the portability.

### Second Embodiment of the Present Invention

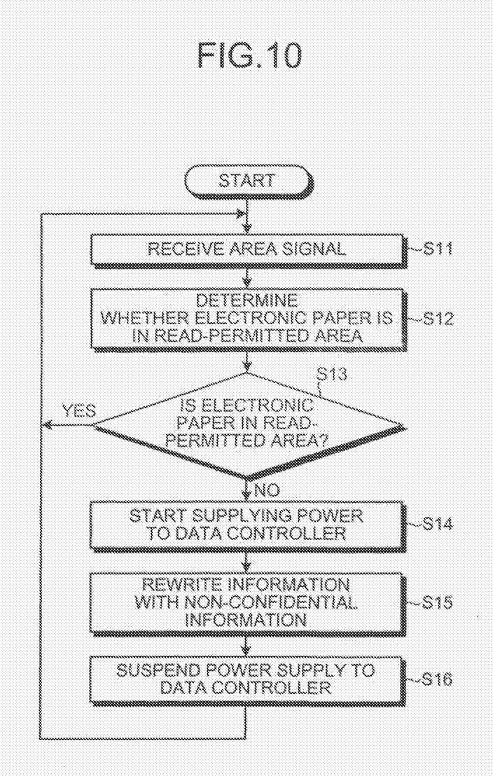

FIG. 11 is a schematic diagram for explaining a display system using electronic paper according to a second embodiment of the present invention. According to the second embodiment, like reference numerals refer to like parts according to the first embodiment, and redundant explanations thereof will be omitted.

Similar to the electronic paper 10, an electronic paper 20 monitors the radio signal from the station 8 all the time, and analyzes the strength, frequency, and modulation information of the monitored signal to determine whether the electronic paper 20 is in the permission area 9.

As shown in FIG. 11, when it is assumed that a user takes out the electronic paper 20 from the permission area 9, the electronic paper 20 determines that it is outside of the permission area 9, cancels the power saving mode, and replaces the confidential information on the display by non-confidential information, as explained according to the first embodiment. Alternatively, the electronic paper 20 deletes the confidential information. Thereafter, the electronic paper 20 turns into the power saving mode.

When the user shifts the electronic paper 20 from outside to inside of the permission area 9, the electronic paper 20 determines that it is in the permission area 9, and cancels the power saving mode to redisplay the confidential information. Thereafter, the electronic paper 20 turns into the power saving mode.

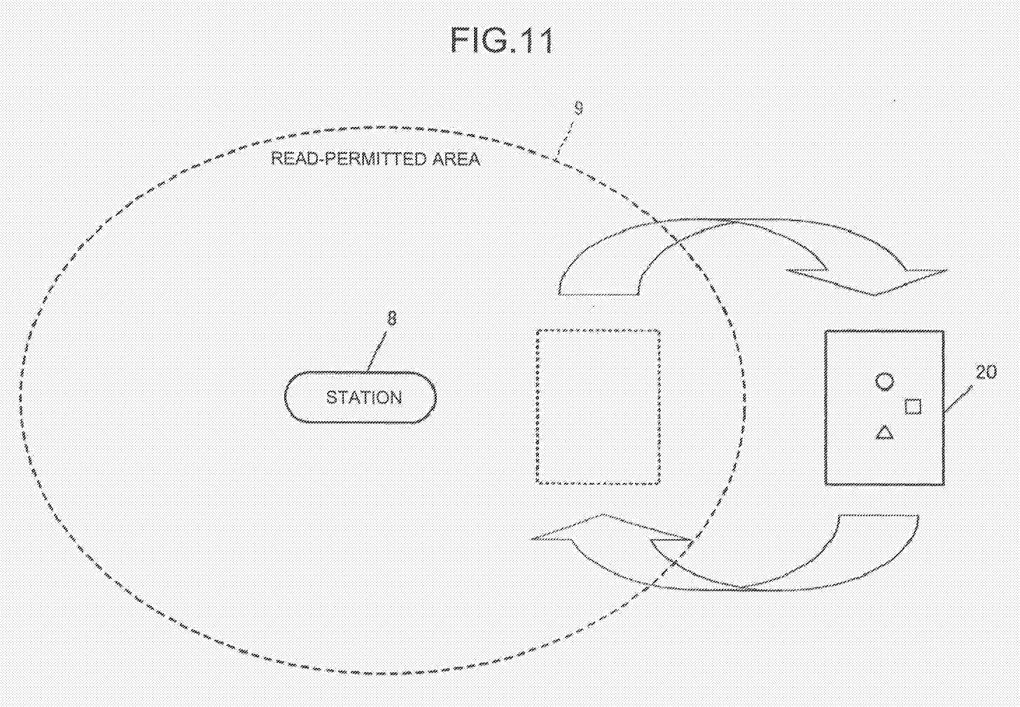

FIG. 12 is a block diagram of the electronic paper according to the second embodiment. The electronic paper 20 includes the display unit 11 that displays information, the driving circuit 12 that drives the display unit 11, the data I/F 13 that receives the information transmitted from the recorder 7 such as a personal computer, a data controller 24 that transmits the received information to the driving circuit 12 to control the operation of the driving circuit 12, the power supply 15 having a charging function, and an area identifying unit 26 that identifies whether the electronic paper is in the permission area.

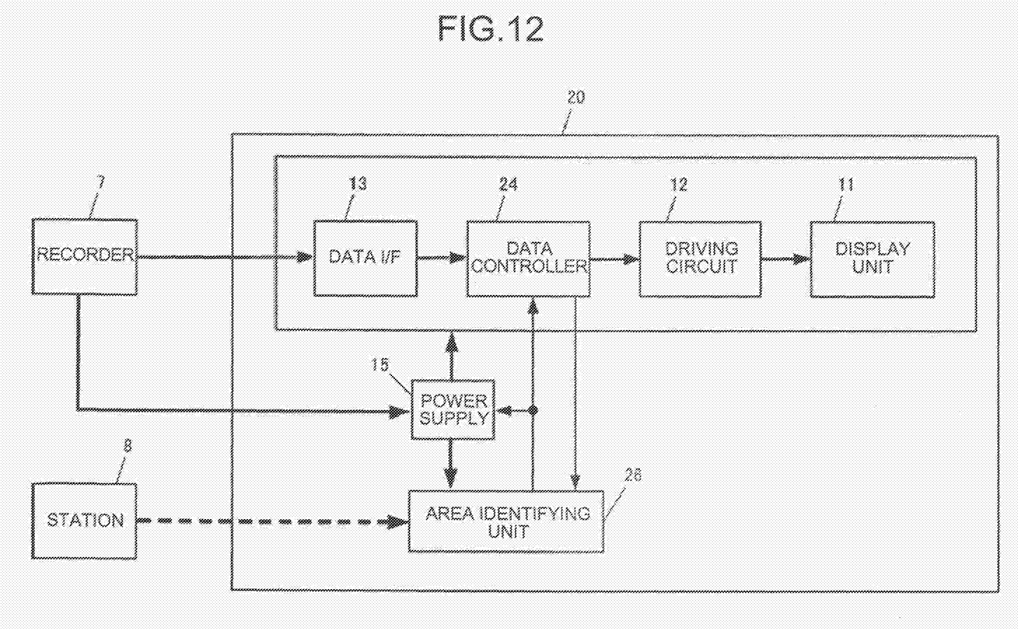

FIG. 13 is a block diagram of the area identifying unit according to the second embodiment. In the area identifying unit 26, the difference from the area identifying unit 16 explained according to the first embodiment is that the control unit 16H is changed to a control unit 26H.

The control unit 26H compares the area indicated by the area recognition information output by the area recognizing unit 16F with the read-permitted information stored in the storage unit 16G. As a result of comparison, when the read-permitted information is changed from an agreement state to a non-agreement state, or when the read-permitted information is changed from the non-agreement state to the agreement state, the control unit 26H outputs a rewrite signal set to High to the data controller 24, and when there is no change in the state, outputs a rewrite signal set to Low to the data controller 24.

When the read-permitted information is changed from the agreement state to the non-agreement state, the control unit 26H outputs a rewrite signal set to Low to the data controller 24, and when the read-permitted information is changed from the non-agreement state to the agreement state, the control unit 26H outputs a rewrite signal set to High to the data controller 24. That is, when the electronic paper 20 is shifted from inside to outside of the permission area, the rewrite signal is set to High.

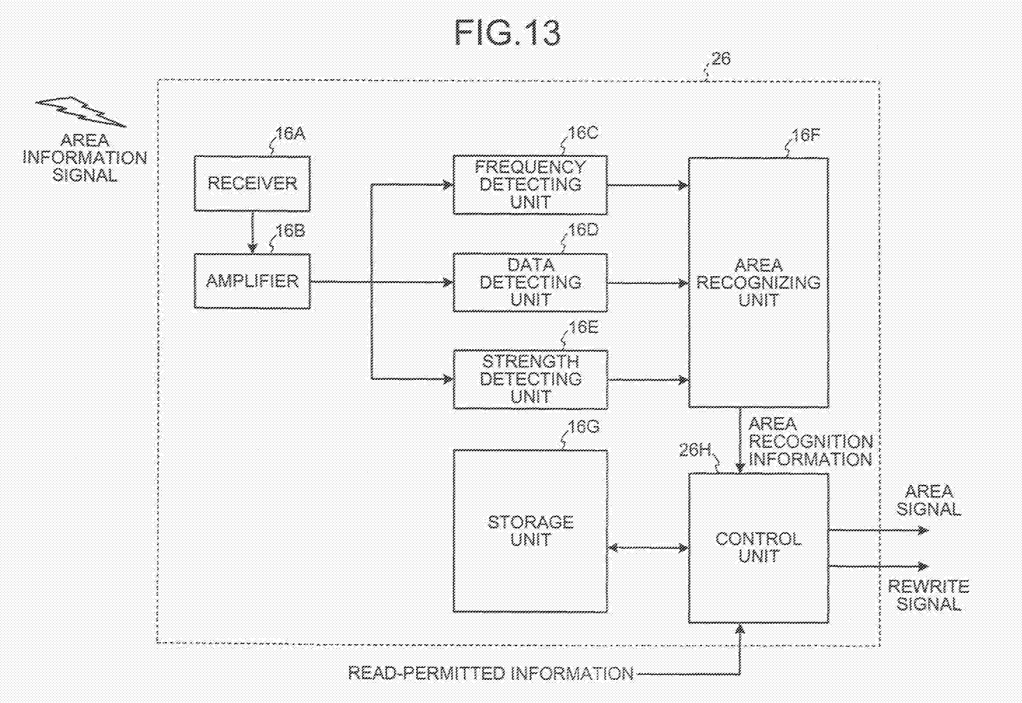

FIG. 14 is a block diagram of the data controller 24 according to the second embodiment. The data controller 24 is formed of the memory 14A that stores the non-confidential information, a memory 24A that stores the confidential information, the header detection circuit 14B that detects the header of the information transmitted from the recorder 7, a write-signal detection circuit 24C that detects a write signal, a selector 24D that selects the memory 14A or the memory 24A, the logic circuits 14E and 14F, and the confidential-flag detection circuit 14G that detects the confidential flag.

The write-signal detection circuit 24C receives information transmitted from the recorder 7 via the header detection circuit 14B to store the displayed information in the received information as confidential information, when the write signal in the received information indicates to operate the driving circuit 12.

The write-signal detection circuit 24C allows the driving circuit 12 to output an enable signal for performing the write operation upon completion of storage of the displayed information in the memory 24A.

An area signal to be output from the area identifying unit 26 is input to the selector 24D. The selector 24D selects the memory 14A when the area signal becomes Low, to output the non-confidential signal stored in the selected memory 14A to the driving circuit 12, and selects the memory 24A when the area signal becomes High, to output the confidential information stored in the selected memory to the driving circuit 12.

An example of the operation of the electronic paper according to the second embodiment is explained with reference to the drawings. An operation for rewriting the displayed information at the time of connection to the recorder is explained with reference to FIG. 9, and only points different from the operation explained in FIG. 9 will be explained.

The data controller 24 does not allow the area identifying unit 26 to output a rewrite signal and an area signal at step S2. At the time of receiving the information shown in FIG. 6A from the recorder 7, the data controller 24 obtains the read-permitted information from the information received at step S4 to store the read-permitted information in the area identifying unit 26, and obtains the displayed information from the received information to store the displayed information as confidential information in the memory 24A.

The data controller 24 rewrites the displayed content on the display unit 11 by the displayed information stored in the memory 24A, when the write signal in the received information indicates to operate the driving circuit 12 at step S5.

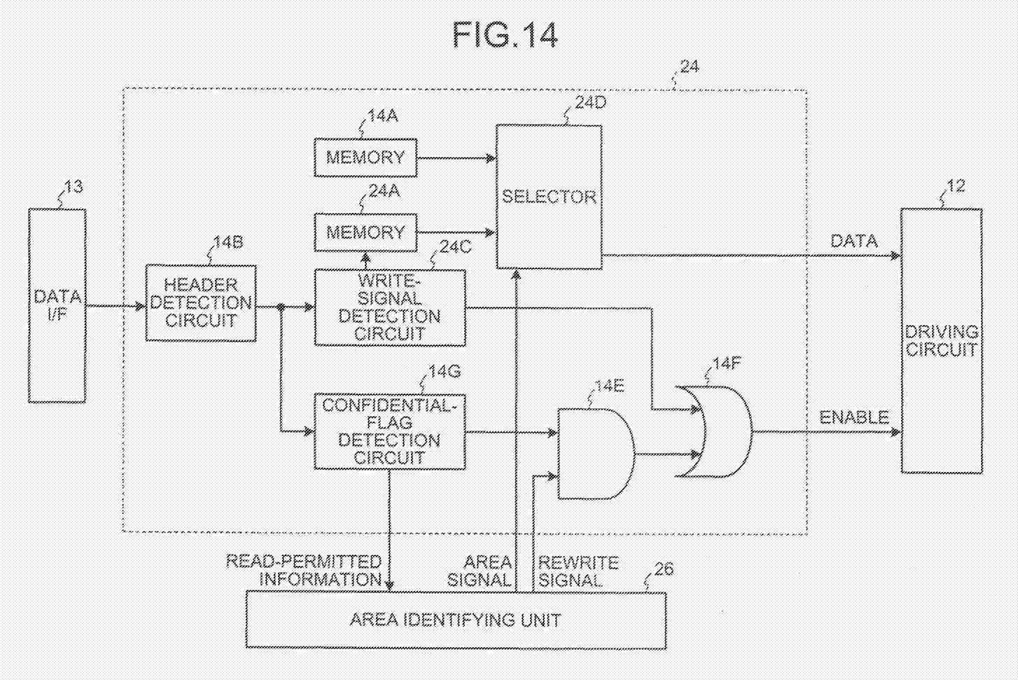

FIG. 15 is a flowchart of an operation when the electronic paper 20 is shifted to inside or outside of the permission area.

The area identifying unit 26 determines whether the area information signal is being received continuously, and compares the received area information with the prestored read-permitted information (step S21), to determine whether the read-permitted information is changed from the agreement state to the non-agreement state, or from the non-agreement state to the agreement state, or the read-permitted information is not at all changed (step S22). The area identifying unit 26 stores the state of the area information signal in the area recognizing unit 16F or the like and compares the current value of the area information signal with a stored previous value of the area information signal to determine the transition state.

When there is no change in the state, the operation proceeds to step S21 (step S23). When the read-permitted information is changed from the agreement state to the non-agreement state, that is, the electronic paper 20 is shifted from the permission area to outside the area, or when the read-permitted information is changed from the non-agreement state to the agreement state, that is, the electronic paper 20 is shifted from outside to inside the permission area, the power supply 15 starts to supply power to the data controller 24 and the like (step S24).

After supplying the power, the data controller 24 determines whether the electronic paper 20 is shifted from inside to outside of the permission area or shifted from outside to inside of the permission area (step S25). When the electronic paper 20 has been shifted from inside to outside of the permission area, to change the rewrite signal from Low to High, the data controller 24 rewrites the displayed content from the confidential information displayed on the display unit 11 to the non-confidential information such as characters of “out of area” or the entire screen is made white (step S26).

When the electronic paper 20 is shifted from outside to inside of the permission area, to change the rewrite signal from Low to High, the data controller 24 rewrites the displayed content from the non-confidential information displayed on the display unit 11 to the confidential information (step S27). After rewrite of the displayed content, the power supply to the data controller 24 and the like is suspended (step S28).

As explained above, the electronic paper according to the second embodiment displays the confidential information, when it is determined that the electronic paper is shifted from outside the area and to inside the area, and therefore the electronic paper can conceal the displayed information in the specific area.

### Third Embodiment of the Present Invention

The electronic paper according to the second embodiment needs to rewrite the displayed content frequently when the electronic paper frequently goes out and comes into the permission area. Even if the display unit 11 has the memory function, when a large amount of power is required for rewrite of the displayed content, a large-capacity battery for supplying the power is required. Therefore, the electronic paper becomes large and heavy, which makes the electronic paper inconvenient.

Further, rewrite from the confidential information to non-confidential information can be rejected, due to no remaining amount of battery required for rewrite. When the electronic paper is left in the permission area without being charged for long time, with the confidential information being displayed thereon, flat battery cannot be avoided. In this case, even if the electronic paper is taken out to outside of the permission area after the battery has run out, the displayed content cannot be changed for concealing the confidential information, because there is no remaining amount of battery required for rewrite.

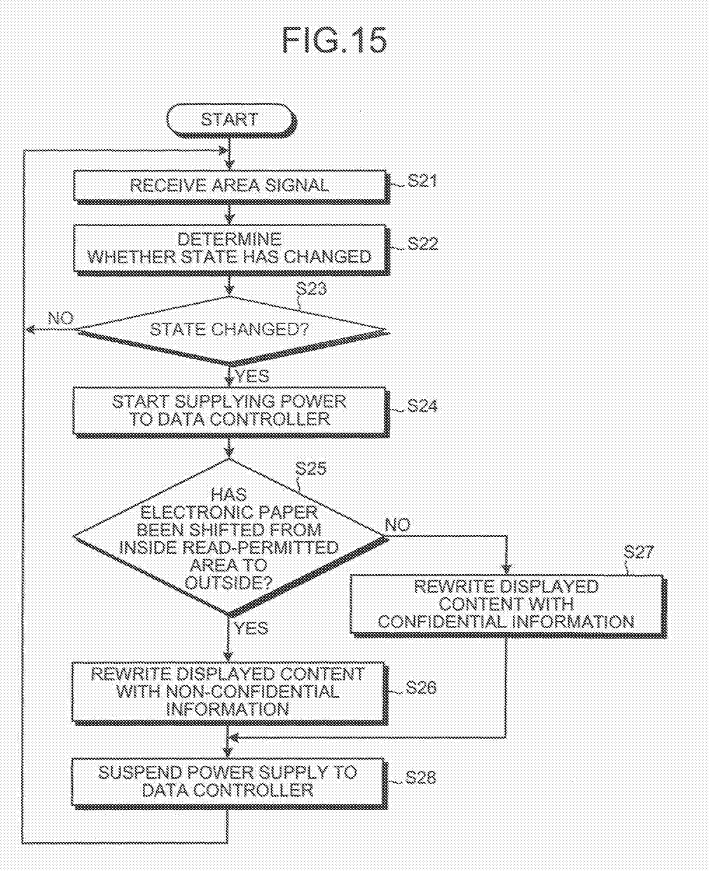

Therefore, a method of the present invention in which rewrite of the display unit is not performed, but another display layer is superposed on the displayed content to conceal the confidential information by the display layer is explained with reference to FIG. 16. The display layer has a two-layer configuration, wherein a microcapsule-electrophoretic display layer is arranged for a first display layer on an inner side for displaying the confidential information, and a two-color liquid crystal is arranged for a second display layer on a surface side in which the liquid crystal is changed to transparent or opaque by ON/OFF of the potential.

The first display layer shown in FIG. 16 is the same as the microcapsule-electrophoretic display layer shown in FIG. 2, and therefore explanations thereof will be omitted. In the second display layer, a transparent electrode is respectively arranged on opposite sides of orientation films, between which a liquid crystal layer is put, and a polarizing plate is respectively arranged outside thereof. In the second display layer, because arrangement of the liquid crystal is changed due to the potential applied to the electrodes, polarization of light passing through the liquid crystal layer changes, and the light is allowed to pass through or blocked according to a combination of the polarizing plate.

The first display layer is not limited to the microcapsule-electrophoretic display layer. However, it is desired to use a display layer having a memory function, which does not require power for maintaining the displayed content. The second display layer is of a low power-consumption type, which can switch two colors (transparent/opaque), has a low resolution, and does not require a back light. In FIG. 16, a glass substrate is used for the second display layer. However, if a film is used instead of the glass substrate, the display unit can be bent.

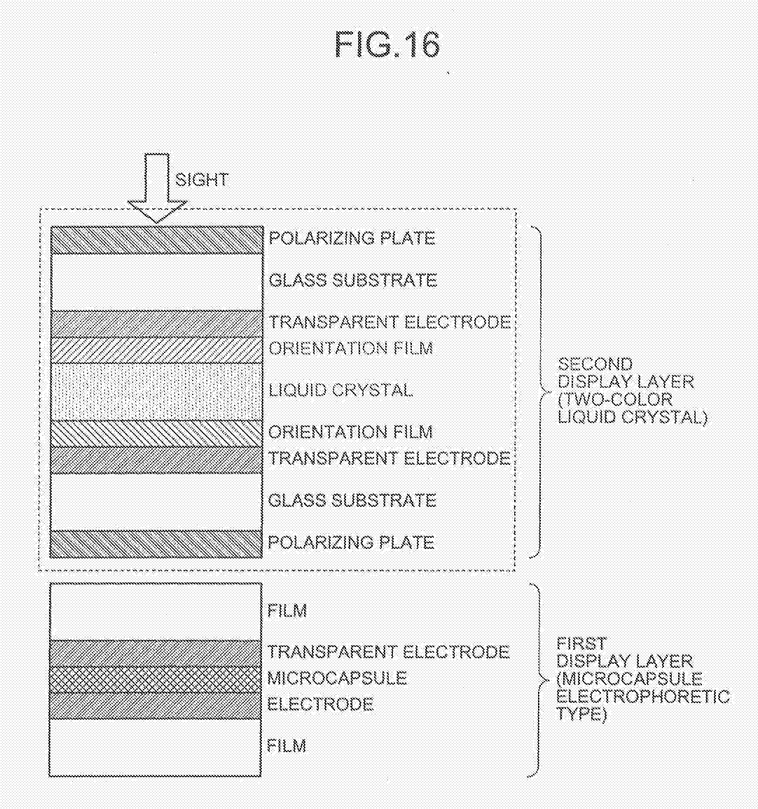

FIG. 17 is a schematic diagram for explaining a generally used TN type liquid crystal. Generally, liquid crystal molecules in the liquid crystal layer are aligned along grooves near the orientation film having the grooves. As shown on the upper left in FIG. 17, when the orientation films arranged above and below the liquid crystal layer are arranged by being shifted by 90 degrees to each other, the liquid crystal molecules between the orientation films are lined up to be twisted. The polarized direction of the light changes to be twisted along the distortion of the liquid crystal molecules. By arranging the polarizing plates to be shifted by 90 degrees, as shown on the lower left in FIG. 17, the light passes through without being twisted. If transparent electrodes are attached to put the orientation films therebetween, the liquid crystal molecules stand up and line up, though not vertical, upon application of potential as shown on the upper right in FIG. 17. Because the polarized direction of the light does not change, the light is blocked by the polarizing plate on the opposite side as shown on the lower right in FIG. 17. That is, the TN type liquid crystal has a property of blocking light when potential is applied and becoming transparent when potential is not applied.

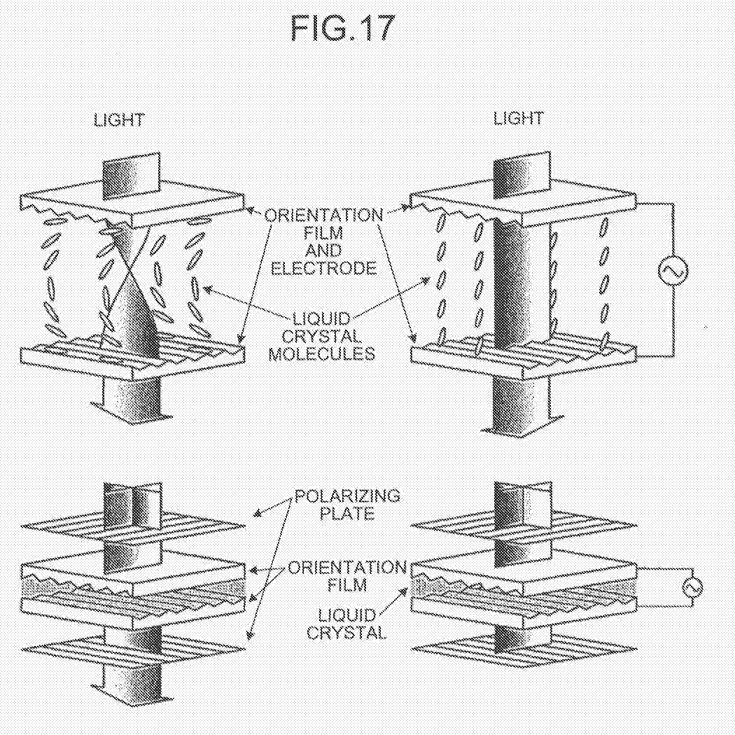

Meanwhile, FIG. 18 is a schematic diagram for explaining a VA type liquid crystal applied to the second display layer shown in FIG. 16. Although the configuration is similar to that of the TN type, the liquid crystal molecules between the orientation films shown in FIG. 16 stand up vertically in the state without potential, and therefore do not affect the polarized direction of the light. In the state with potential being applied, the liquid crystal molecules do not stand up vertically, and therefore the polarization is changed. Therefore, the VA type liquid crystal has a property of transmitting light when potential is applied and blocking light when potential is not applied. Further, an MVA type, which improves an angle of visibility in the VA type, and an IPS type in which the electrode is attached to a horizontal plane also have the property of transmitting light when potential is applied and blocking light when potential is not applied.

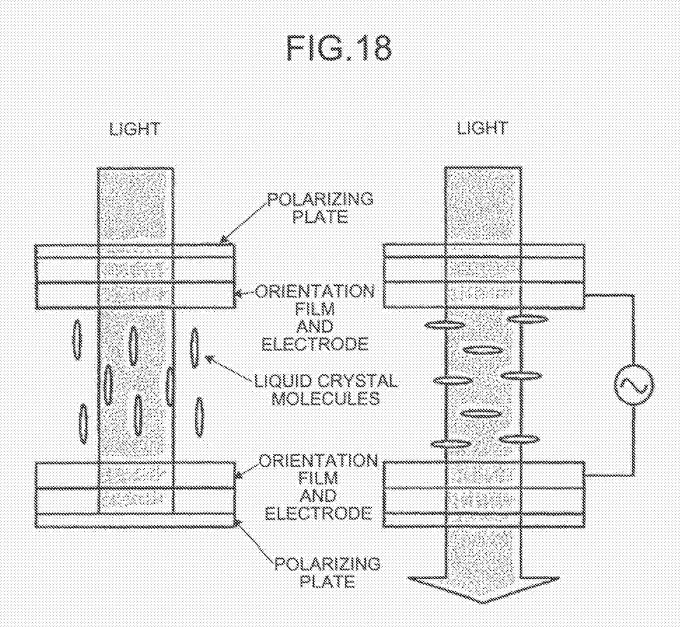

FIG. 19 is a block diagram of electronic paper according to a third embodiment of the present invention, which uses the display unit that transmits light in the state with potential being applied, and blocks light in the state without potential as shown in FIG. 18. According to the third embodiment, like reference numerals refer to like parts according to the first embodiment, and redundant explanations thereof will be omitted.

An electronic paper 30 includes a first display unit 31 having the first display layer shown in FIG. 16, a second display unit 37 having the second display layer shown in FIG. 16, a first driving circuit 32 that drives the first display unit 31, a driving circuit 38 that drives the second display unit 37, the data I/F 13 that receives the information transmitted from the recorder 7, a data controller 34 that transmits the received information to the first driving circuit 32 and controls the operation of the first driving circuit 32, a power supply 35 having a charging function, and an area identifying unit 36 that identifies whether the electronic paper 30 is in the permission area. In the electronic paper 30, the first and second display layers are arranged in an overlapped state.

The first display unit 31 is desirably formed of the one having the memory function, such as the microcapsule electrophoretic type or the twist ball type shown in the figures. In the second display unit 37, it is desired to use a liquid crystal that becomes opaque in the state without potential to block light as shown in FIG. 18, such as the VA or IPS type liquid crystal, for the second display layer shown in FIG. 16.

The data I/F 13 and the recorder 7 are connected to the data controller 34. Upon reception of the displayed information transmitted from the recorder 7 via the data I/F 13, the data controller 34 transmits the received displayed information to the first driving circuit 32 to be displayed on the first display unit 31.

The area identifying unit 36 determines whether the electronic paper 30 is in the permission area by, for example, wirelessly receiving the area information signal indicating the permission area from the station 8. A method for determining whether the electronic paper 30 is in the permission area by the area identifying unit 36 is the same as in the area identifying unit 16.

When the area identifying unit 36 determines that the electronic paper 30 is in the permission area, the area identifying unit 36 controls the driving circuit 38 to supply power to the second display unit 37, thereby making the display layer in the second display unit 37 transparent. When determining that the electronic paper 30 is outside of the permission area, the area identifying unit 36 controls the driving circuit 38 to suspend the power supply to the second display unit 37, thereby making the display layer in the second display unit 37 opaque. As a method for making the display layer opaque, not only the method in which the area identifying unit 36 controls the driving circuit, but also a method in which power supply to the driving circuit 38 and the second display unit 37 is suspended can be used.

The power supply 35 has a capacitor as a charging function, which is charged when being connected to the recorder 7. When the electronic paper 30 is connected to the recorder 7, the power supply 35 supplies power to the respective blocks in the electronic paper 30. Because the data I/F 13, the data controller 34, the first driving circuit 32, and the first display unit 31, which is the first display means, operate only when the electronic paper 30 is connected to the recorder 7. The power supply 35 can be configured in order not to supply power to the data I/F 13, the data controller 34, the first driving circuit 32, and the first display unit 31 as the first display means, when the recorder 7 is cut off from the electronic paper 30.

An example of the operation of the electronic paper according to the third embodiment is explained with reference to the drawings. An operation for rewriting the displayed information at the time of being connected to the recorder is explained with reference to FIG. 9, and only a different point from FIG. 9 is explained.

At step S2, the data controller 34 suspends control whether to supply power to the area identifying unit 36, and starts this control at step S7. However, steps S2 and S7 may not be performed. Upon reception of the information shown in FIG. 6A from the recorder 7, the data controller 34 obtains the read-permitted information from the information received at step S4 to store the read-permitted information in the area identifying unit 36, obtains the displayed information from the information received at step S5, and transmits the displayed information as the confidential information to the first driving circuit 32 to be displayed on the first display unit 31.

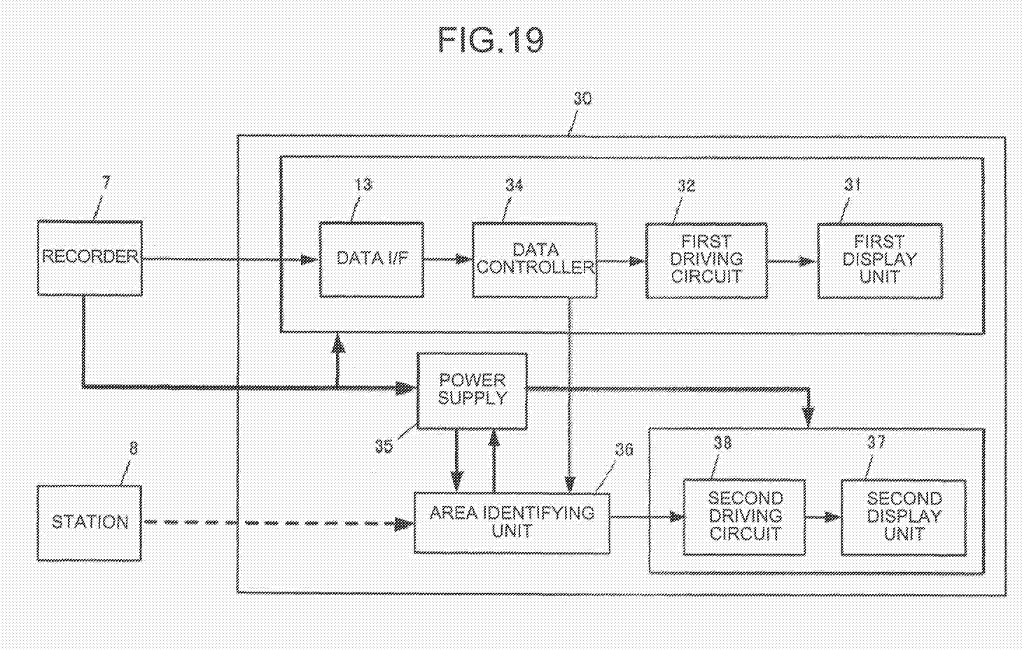

FIG. 20 is a flowchart of an operation when the electronic paper 30 displaying the confidential information thereon is shifted to outside of the permission area.

The area identifying unit 36 determines whether the area information signal is being received continuously, and compares the received area information with the prestored read-permitted information (step S31), to determine whether the read-permitted information is changed from the agreement state to the non-agreement state, or from the non-agreement state to the agreement state, or the read-permitted information is not at all changed (step S32).

When there is no change in the state, the operation proceeds to step S31 (step S33). The area identifying unit 36 determines whether the read-permitted information is changed from the agreement state to the non-agreement state, that is, the electronic paper 30 is shifted from the permission area to outside the area, or the read-permitted information is changed from the non-agreement state to the agreement state, that is, the electronic paper 30 is shifted from outside to inside of the permission area (step S34).

When the electronic paper 30 is shifted from the permission area to outside of the area, the area identifying unit 36 controls the driving circuit 38 to suspend power supply to the second display unit 37 to make the display layer opaque, thereby concealing the displayed content on the first display unit 31 (step S35). Even when the remaining amount of battery in the power supply 35 becomes zero to suspend the power supply to the liquid crystal display layer in the second display unit 37, the confidential information displayed on the first display layer is concealed.

On the other hand, when the electronic paper 30 is shifted from outside to inside of the permission area, the area identifying unit 36 controls the driving circuit 38 to supply power to the second display unit 37 to make the display layer transparent, thereby displaying the displayed content on the first display unit 31 (step S36).

As explained above, when it is determined that the electronic paper is shifted from the permission area to outside of the permission area, the electronic paper according to the third embodiment can conceal the confidential information in the specific area by controlling the second display unit 37 in order not to display the displayed information displayed on the second display unit 37. Accordingly, even if the battery runs out by any chance, because the display layer in the second display unit 37 becomes all black (opaque), the first display layer in the first display unit 31 is covered and hidden to prevent leakage of the confidential information.

The embodiments of the present invention have been explained. In another mode of the present invention, as the method for enabling display in the permission area, if not only the area information signal transmitted from the station, but ID information such as RFID for specifying a mobile object such as a person are used, the measure against the leakage of confidential information can be reinforced.

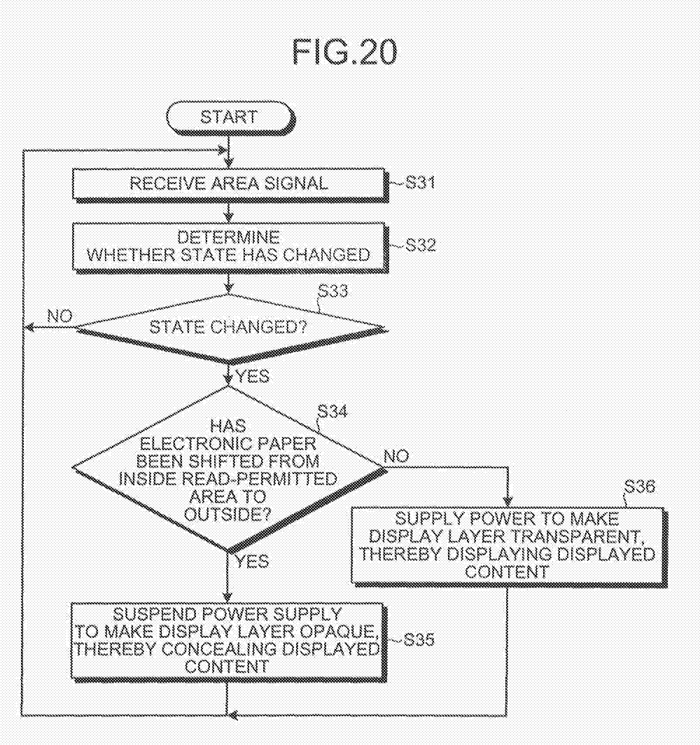

For example, as shown in FIG. 21, a function for receiving a signal indicating an individual RFID as well as the area information signal transmitted from the station is provided to the area identifying unit in the electronic paper according to the present invention. A station ID indicating the station A and an RFID indicating an individual B are associated with each other in the read-permitted information shown in FIG. 6B, so that the electronic paper permits only the individual B to read the information only in a surrounding area of the station A. When the RFID of the individual B is detected together with the ID of the station A, the electronic paper shown in FIG. 21 permits reading of the confidential information only in an area where the area of the station A overlaps on the surrounding area of the individual B.

The power supply of the electronic paper is charged at the time of being connected to the recorder. In another mode of the present invention, charging can be performed by using electromotive force generated by radio waves from the station. The power supply in the electronic paper can have a monitoring function of the remaining power amount, so that when there is no remaining power sufficient for performing rewrite of the display unit in the electronic paper for specified number of times, the data controller does not allow the display unit to display the confidential information transmitted from the recorder, that is, rejects update of the displayed content.

This is because when there is not enough power required for deleting the display on the display unit or displaying non-confidential information on the display unit, even if the electronic paper is taken out to outside of the permission area, it can prevent a case that rewrite of the confidential information to the non-confidential information cannot be performed due to short of power. Of course, this protective function can be realized not only in the electronic paper, but also realized in a systematic manner such that when the electronic paper is connected to the recorder, the recorder monitors power failure of the electronic paper.

The read-permitted information is stored in the area identifying unit according to the embodiments of the present invention. However, the read-permitted information can be rewritten every time when the displayed information to be transmitted from the recorder is updated, or a manager sets the read-permitted information in a batch manner according to the security policy of the station, so that general users cannot rewrite the information. Furthermore, a plurality of types of read-permitted information can be prepared and stored, and read of the information can be permitted only in a specific station or in a unit of group readable over a plurality of stations.

### INDUSTRIAL APPLICABILITY

The display apparatus and the display system according to the present invention are useful for display apparatuses and display systems having portability and rewritability such as electronic paper, and particularly suitable for concealing displayed information in a specific area.

1-19. (canceled)

20. A display apparatus comprising:
a display unit configured to display information without a power supply;
an area identifying unit configured to determine whether the display apparatus is inside a permission area where a read of the information displayed on the display unit is permitted; and
a data controller configured to delete the information displayed on the display unit or to display other information on the display unit, when the area identifying unit determines that the display apparatus has moved from inside the permission area to outside the permission area.

21. The display apparatus according to claim 20, wherein the data controller displays the information on the display unit, when the area identifying unit determines that the display apparatus moves to the inside permission area.

22. The display apparatus according to claim 20, wherein the data controller is configured to further determine whether the information displayed on the display unit is confidential or not by using a flag indicating the information is confidential or not, and to maintain the information displayed on the display unit if the information is not confidential.

23. The display apparatus according to claim 20, further comprising a data interface configured to receive information transmitted from a recorder, wherein
the data controller displays the information received from the data interface on the display unit.

24. The display apparatus according to claim 23, further comprising a power supply configured to monitor a remaining power, wherein
the data controller does not display the information received from the data interface on the display unit when the remaining power is less than a predetermined level.

25. The display apparatus according to claim 24, wherein the predetermined level is a power level required for deleting the display of the information on the display unit or displaying the other information on the display unit.

26. The display apparatus according to claim 20, further comprising a power supply controller configured to control a supply of power, wherein
the power supply controller suspends the supply of power to the data controller when the area identifying unit determines that the display apparatus is outside the permission area.

27. The display apparatus according to claim 20, wherein
the area identifying unit is configured to further determine whether the display apparatus is in a surrounding area of a specific person,
the data controller displays the information on the display unit and the data controller deletes the display of the information on the display unit or displays the other information on the display unit when the area identifying unit determines that the display apparatus is not inside the area or not in the surrounding area of the specific person.

28. The display apparatus according to claim 21, wherein
the data controller includes
a first memory configured to store the information to be displayed on the display unit,
a second memory configured to store different information of the information stored in the first memory, and
a selector configured to select the first memory to display the information stored in the first memory on the display unit when the area identifying unit determines that the display apparatus moves from the outside permission area to the inside permission area, and select the second memory to display the other information stored in the second memory on the display unit when the area identifying unit determines that the display apparatus moves from the inside permission area to the outside permission area.

29. A display system comprising:
a display apparatus including
a display unit configured to maintain a display of information without a power supply,
an area identifying unit configured to determine whether the display apparatus is inside a permission area where a read of the information displayed on the display unit is permitted, and
a data controller configured to delete the display of the information on the display unit or display other information on the display unit, when the area identifying unit determines that the display apparatus moves from inside the permission area to outside the permission area; and
a station configured to transmit a permission area information signal indicating information of an permission area, wherein
the display apparatus receives the permission area information signal transmitted from the station, and determines whether the display apparatus is inside the permission area or outside the permission area, based on the received permission area information signal.

30. A display method comprising:
displaying including a display unit displaying information without a power supply;
determining whether a display apparatus is inside a permission area where a read of the information displayed on the display unit is permitted; and
controlling including a data controller deleting the information displayed on the display unit or to display other information on the display unit, when it is determined that the display apparatus has moved from inside the permission area to outside the permission area.

31. The display method according to claim 30, wherein the data controller displays the information on the display unit, when the area identifying unit determines that the display apparatus moves to the inside permission area.

32. The display method according to claim 30, wherein the controlling further includes
determining whether the information displayed on the display unit is confidential or not by using the flag indicating the information is confidential or not, and
maintaining the information displayed on the display unit if the information is not confidential.

33. The display method according to claim 30, further comprising receiving information transmitted from a recorder, wherein
the controlling includes displaying the information received at the receiving on the display unit.

34. The display method according to claim 33, further comprising monitoring a remaining power, wherein
the controlling includes not displaying the information received at the receiving on the display unit when the remaining power is less than a predetermined level.

35. The display method according to claim 34, wherein the predetermined level is a power level required for deleting the display of the information on the display unit or displaying the other information on the display unit.

36. The display method according to claim 30, further comprising controlling a supply of power, wherein
the controlling a supply of power includes suspending the supply of power to the data controller when it is determined that the display apparatus is outside the permission area.

37. The display method according to claim 30, wherein
the determining includes determining whether the display apparatus is in a surrounding area of a specific person,
the controlling includes
displaying the information on the display unit, and
deleting the display of the information on the display unit or displaying the other information on the display unit when it is determined that the display apparatus is not inside the area or not in the surrounding area of the specific person.

38. The display method according to claim 31, wherein
the controlling includes
storing including a first memory storing the information to be displayed on the display unit,
storing including a second memory storing different information of the information stored in the first memory, and
selecting the first memory to display the information stored in the first memory on the display unit when it is determined that the display apparatus moves from the outside permission area to the inside permission area, and selecting the second memory to display the other information stored in the second memory on the display unit when it is determined that the display apparatus moves from the inside permission area to the outside permission area.
